(19) United States
(12) Patent Application Publication
(10) Pub. No.: US 2023/0229503 A1
(43) Pub. Date: Jul. 20, 2023

(54) EFFICIENT USE OF COMPUTING RESOURCES FOR OPTIMIZATION OF NON-CONVEX FUNCTIONS

(71) Applicant: INTUIT INC., Mountain View, CA (US)

(72) Inventors: Xue HAN, Sunnyvale, CA (US); Zhicheng XUE, Union City, CA (US); Wei WANG, Santa Clara, CA (US); Nazanin Zaker HABIBABADI, Sunnyvale, CA (US); Yue YU, Mountain View, CA (US)

(21) Appl. No.: 17/647,998

(22) Filed: Jan. 14, 2022

(51) Int. Cl. G06F 9/50

(52) U.S. Cl. CPC G06F 9/5027

(57) ABSTRACT

Aspects of the present disclosure provide techniques for efficiently utilizing physical computing resources for non-convex function approximation. Embodiments include determining a model formulation for determining a target value based on one or more constraints, wherein the model formulation comprises a non-convex function. Embodiments include converting the model formulation into a mixed integer programming (MIP) model, wherein the converting involves determining, based on the non-convex function, a first convex function and a second convex function. Embodiments include solving the MIP model, including computing a first piecewise linear approximation of the first convex function, computing a second piecewise linear approximation of the second convex function, and determining a difference between the first piecewise linear approximation and the second piecewise linear approximation to produce an approximated result of the non-convex function. Embodiments include performing one or more actions based on the target value, which is determined based on the approximated result.

### INTRODUCTION

Aspects of the present disclosure relate to techniques for computationally efficient optimization of non-convex functions.

### BACKGROUND

Every year millions of people, businesses, and organizations around the world utilize software applications to assist with countless aspects of life. Commerce in particular has been significantly impacted by advances in computing technology. Many software applications provide various commercial services, such as performing financial management and allowing users to conveniently buy and sell products and services.

Some software applications provide automated services for determining target values, such as pricing of products and services. For example, a software application may be programmed with rules for setting or recommending prices for products and/or services based on various criteria, such as the identity, type, and quantity of a product or service. However, these existing techniques tend to be rigid, and often do not take into account many factors that affect pricing. Furthermore, when a large number of factors are taken into consideration, computations may become complex and inefficient.

What is needed is a solution for optimization of target values that takes into account various factors in a manner that is suited for computation on modern computing systems.

### BRIEF SUMMARY

Certain embodiments provide a method for efficiently utilizing physical computing resources for non-convex function approximation. The method generally includes: determining a model formulation for determining a target value based on one or more constraints, wherein the model formulation comprises a non-convex function involving a product of two decision variables; converting the model formulation into a mixed integer programming (MIP) model, wherein the converting comprises determining, based on the non-convex function, a first convex function and a second convex function; solving the MIP model, wherein the solving comprises: computing a first piecewise linear approximation of the first convex function; computing a second piecewise linear approximation of the second convex function; and producing an approximated result of the non-convex function based on determining a difference between the first piecewise linear approximation and the second piecewise linear approximation; determining the target value based on the approximated result of the non-convex function; and performing one or more actions based on the target value.

Other embodiments provide a method for efficiently utilizing physical computing resources for non-convex function approximation. The method generally includes: determining a model formulation for determining target value information based on one or more constraints, wherein the model formulation comprises a non-convex function involving a product of two decision variables; converting the model formulation into a mixed integer programming (MIP) model, wherein the converting comprises determining, based on the non-convex function, a first convex function and a second convex function; solving the MIP model, using an MIP solver, wherein the solving comprises: computing a first piecewise linear approximation of the first convex function based on a Taylor polynomial expansion; computing a second piecewise linear approximation of the second convex function based on connecting lines across a plurality of points on a curve of the second convex function; and producing an approximated result of the non-convex function based on determining a difference between the first piecewise linear approximation and the second piecewise linear approximation; determining the target value information based on the approximated result of the non-convex function; determining a user segment to which a user corresponds based on attributes of the user; and providing a message to the user based on the target value information and the user segment to which the user corresponds.

Other embodiments provide a system comprising one or more processors and a non-transitory computer-readable medium comprising instructions that, when executed by the one or more processors, cause the system to perform a method. The method generally includes: determining a model formulation for determining a target value based on one or more constraints, wherein the model formulation comprises a non-convex function involving a product of two decision variables; converting the model formulation into a mixed integer programming (MIP) model, wherein the converting comprises determining, based on the non-convex function, a first convex function and a second convex function; solving the MIP model, wherein the solving comprises: computing a first piecewise linear approximation of the first convex function; computing a second piecewise linear approximation of the second convex function; and producing an approximated result of the non-convex function based on determining a difference between the first piecewise linear approximation and the second piecewise linear approximation; determining the target value based on the approximated result of the non-convex function; and performing one or more actions based on the target value.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example related to efficiently utilizing physical computing resources for function optimization.

FIG. 2A depicts an example of computing components related to efficiently utilizing physical computing resources for function optimization.

FIG. 2B depicts an example of efficiently utilizing physical computing resources for non-convex function approximation.

FIG. 3 depicts an example of a user interface screen for optimized offers.

FIG. 4 depicts example operations for efficiently utilizing physical computing resources for function optimization.

FIGS. 5A and 5B depict example processing systems for efficiently utilizing physical computing resources for function optimization.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for performing computationally efficient optimization of con-convex functions.

Embodiments described herein involve constructing a model for optimization (e.g., for optimization of pricing or other target values) based on various constraints and, in certain embodiments, structuring functions in the model in such a manner as to efficiently utilize physical computing resources. The constraints may include, for example, minimum and/or maximum variable values (e.g., prices, losses, profits, time), likelihood of particular outcomes (e.g., offer acceptance, availability, etc.), and/or the like. For instance, a model may relate to loan pricing for customer lending, and certain constraints may be based on known relationships among percentage rates, propensity to accept offers, amount of loss (e.g., due to failure of customers to pay), loan volume, loan term, and/or the like.

For a consumer lending product to be successful, it should generally provide competitive Annual Percentage Rate (APR) offerings to attract customers while achieving a certain rate of return to recuperate the cost of capital and operating overhead. Before a new product is launched, a lender will conventionally obtain data from third-party sources and/or conduct marketing experiments on a similar customer base to that for which the new product is intended. Customers may then be grouped into multiple credit risk segments, and different APRs may be assigned to different risk segments. Certain techniques described herein solve the problem of assigning minimum APRs to risk segments such that the complex relationships among interest rate, propensity to take loan offer, loan volume, and loss are taken into account, yet the minimum rate of return is not violated.

Certain relationships, such as that between percentage rate and propensity to accept an offer, are typically represented as non-convex functions. A non-convex function generally refers to a function that includes multiple feasible regions and multiple locally optimal points within each region. As such, it can take a considerable amount of time to determine that a non-convex function is infeasible or unbounded, or that a locally optimal solution is the global optimum across all feasible regions. Non-convex functions are therefore difficult and time-consuming to evaluate on computing devices, resulting in large amounts of physical computing resource utilization. Thus, techniques described herein involve approximating a non-convex function as the difference between piecewise linear functions, and utilizes a Taylor polynomial expansion (e.g., first degree) to simplify exponential constraints. Taylor's theorem, in calculus, gives an approximation of a k-times differentiable function around a given point by a polynomial of degree k, called the kth degree Taylor polynomial, with the first degree Taylor polynomial being the linear approximation of the function.

Accordingly, embodiments of the present disclosure convert a non-convex function into a mixed integer programming (MIP) problem that can be evaluated with smaller amounts of physical computing resources and, in some cases, computed more efficiently through parallel processing. Furthermore, techniques described herein involve utilizing objective functions that maximize other values, such as total loan volume for product market expansion and total profit.

Techniques described herein improve the technical field of automated function optimization in a number of ways. For instance, by converting a non-convex function into a mixed integer programming (MIP) problem that can be evaluated with fewer computing resources while also, in some cases, leveraging parallel computing arrangements, techniques described herein improve the functioning of computer systems involved in the automated function optimization process. Furthermore, by approximating non-convex functions in the resource-efficient manner described herein, embodiments of the present disclosure allow complex relationships such as that between price increase and propensity to accept an offer to be taken into consideration during automated function optimization in a way that was not previously possible without expending excessive amounts of physical computing resources and time.

Additionally, by reflecting a variety of constraints in an MIP model, including constraints defined by an offer provider and constraints related to known relationships among different elements related to a target value, with the MIP model being configured in such as manner as to be evaluated efficiently (e.g., without requiring directly evaluating non-convex functions), techniques described herein improve the automated function optimization such that offers can be more effectively targeted to particular customers, such as in real time based on attributes of the customers.

### Example of Efficiently Utilizing Physical Computing Resources for Function Optimization

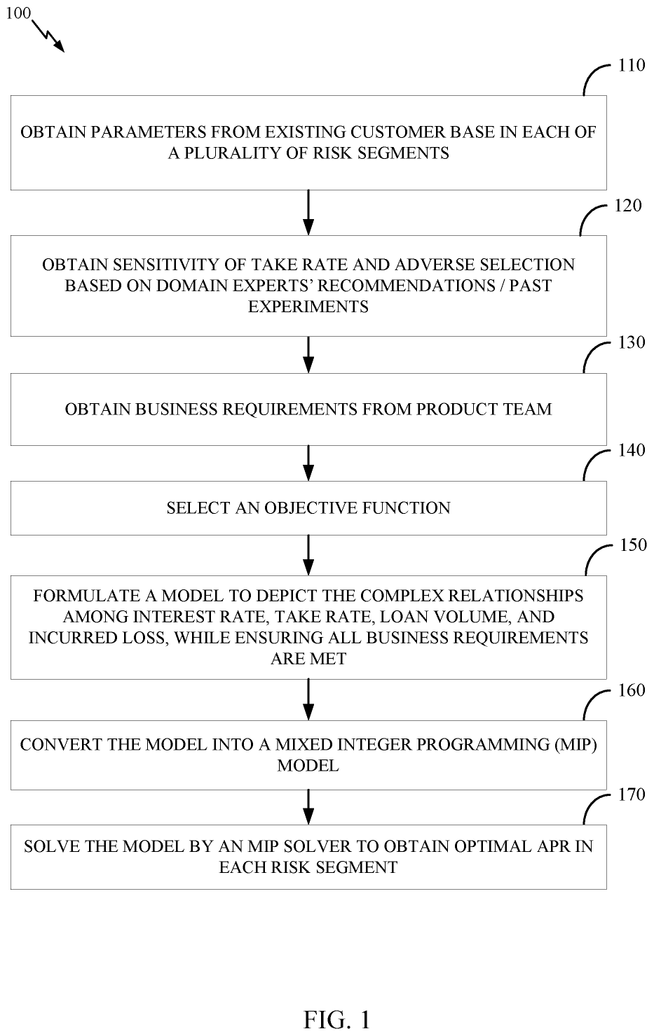

FIG. 1 is an illustration 100 of an example related to efficiently utilizing physical computing resources for function optimization. For example, illustration 100 may relate to techniques for generating and solving an MIP model in a resource-efficient manner to determine optimal pricing for customer risk segments.

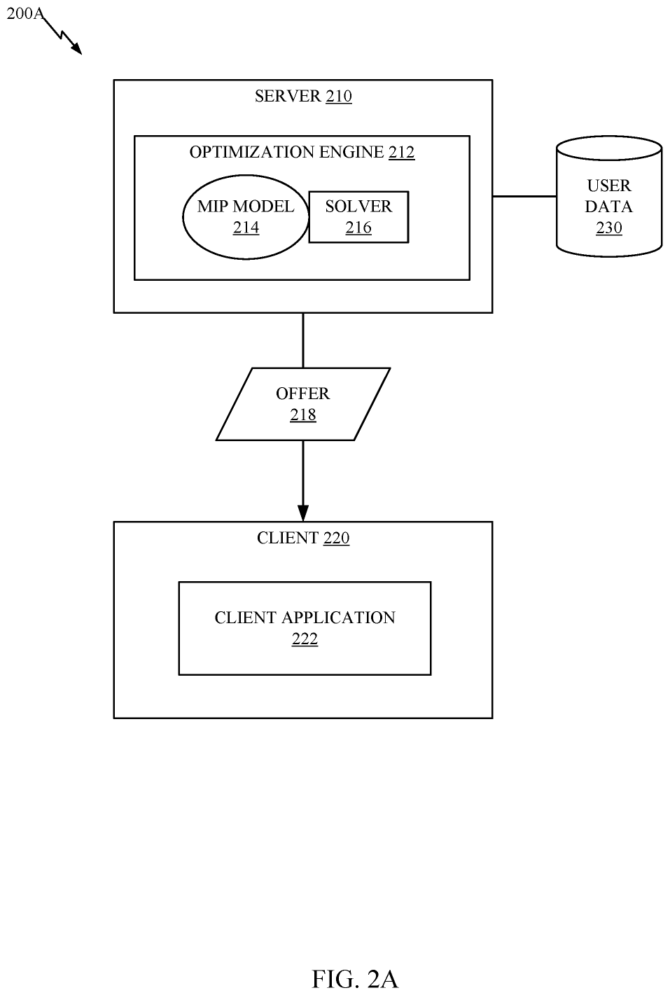

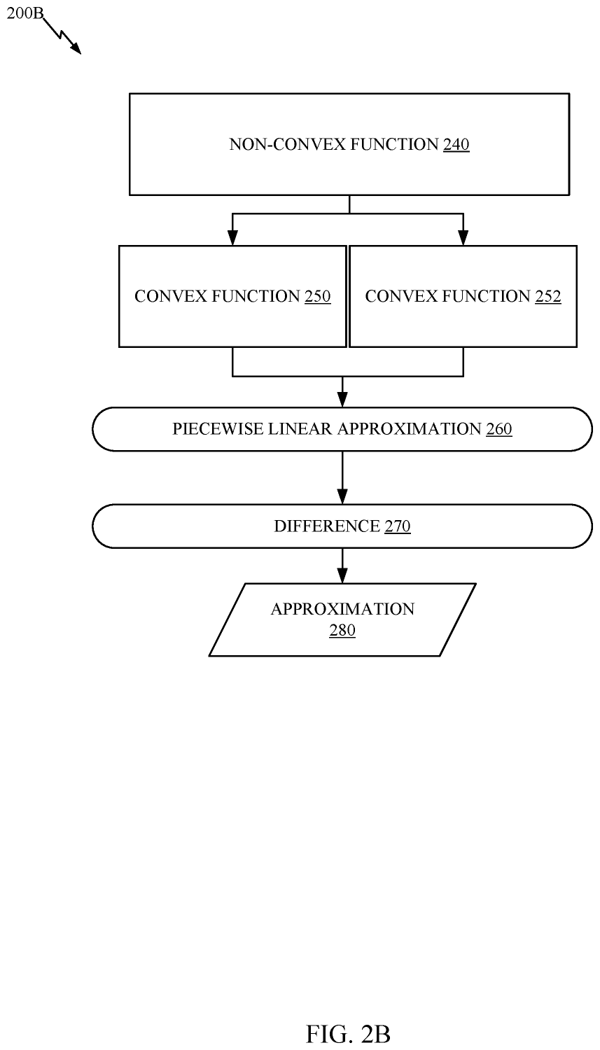

Steps 110-170 are described at a high level with respect to FIG. 1, and additional details are provided below with respect to FIG. 2A.

At step 110, parameters are obtained from an existing customer base in each of a plurality of risk segments. For example, the parameters may be obtained from third-party data related to historical funded loans, and may include, for example, a base annualized loss rate, a base annual percentage rate (APR) (e.g., representing a yearly interest generated by a sum that's charged to borrowers or paid to investors), a base annualized interest yield, a base proportion of total funded volume, a base take rate, and/or the like.

At step 120, a sensitivity of take rate (e.g., propensity to take offers) and adverse selection is obtained based on domain experts' recommendations and/or past experiments (e.g., market experiments). The sensitivity of take rate may refer to a percent reduction of an offer acceptance rate when APR is increased by one increment (e.g., one percentage point or another increment). Adverse selection may refer to a a factor that augments an annualized loss rate when a take rate is smaller than the base take rate in a segment. Constraints obtained from domain experts (e.g., experts in consumer lending) and/or past experiments (e.g., marketing experiments on a similar customer base to that for which the new product is intended) may include minimum net annual return (NAR) (e.g., an annualized measure of the rate of return on actual investments made in loans), minimum APR that could be offered, maximum APR that could be offered, an increment by which APR is to increase and/or decrease (e.g., a step), a minimum difference of APRs offered between two adjacent segments, a minimum proportion of total volume in a segment, a maximum proportion of total volume in a segment, and/or the like.

At step 130, business requirements are obtained from the product team (e.g., one or more individuals related to a new consumer lending product to be offered). The business requirements may include a term of a loan in number of months for monthly repayment, a minimum net annual return (e.g., a rate of return that should compensate costs of funding the loan and other overhead operating cost plus any profit margin the product would like to achieve), a minimum and/or maximum APR that could be offered for the product, a minimum step of APR increases/decreases (e.g., APR must be a multiple of the step, such as 0.025%), a minimum difference between APRs in adjacent risk segments, loan concentration information such as a minimum and/or maximum proportion of volume in each segment, and/or the like. In some embodiments, the business requirements are received via input provided to a user interface.

At step 140, an objective function is selected. An objective function attempts to optimize one or more target variables based on a set of constraints and relationships among one or more decision variables. For instance, the objective function may relate to a variety of different objectives, such as (in the context of consumer lending products) maximizing APR reduction from current pricing offered to a customer base, maximizing total loan volume, maximizing total profit, and/or the like. Example objective functions are described in more detail below with respect to FIG. 2A.

At step 150, a model is formulated to depict the complex relationships among interest rate, take rate, loan volume, and incurred loss (e.g., losses that an entity has sustained during a reporting period), while ensuring all business requirements are met. For example, as APR increases from the base value for a segment, fewer customers in that segment are likely to accept the offer, thus decreasing the loan volume in this segment. Furthermore, customers who accept a higher APR are likely higher-risk customers due to their willingness to obtain funds despite the high cost, so the loss in that segment is likely to increase (e.g., due to failure to pay). This phenomenon is generally referred to as adverse selection in the lending industry. These complex relationships introduce non-convex terms into the model, making it difficult to solve using existing solution methodologies. Non-convex functions are described in more detail below with respect to FIG. 2A.

At step 160, the model is converted into a mixed integer programming (MIP) model so that it can be solved by an MIP solver in a relatively short time period and with optimal utilization of physical computing resources, such as processing resources. This may include simplifying exponential terms into a linear form by utilizing a Taylor polynomial expansion, as described in more detail below with respect to FIG. 2A. In some embodiments, as described in more detail below with respect to FIGS. 2A and 2B, each non-convex term is formulated as the difference between two convex and separable functions, and piecewise linear function approximation is applied to the convex functions.

At step 170, the model is solved by an MIP solver, such as an open source or commercial MIP solver, as described in more detail below with respect to FIG. 2A, to obtain an optimal APR in each risk segment.

### Example Computing Components Related to Efficiently Utilizing Physical Computing Resources for Non-Convex Function Optimization

FIG. 2A is an illustration 200A of example computing components related to efficiently utilizing physical computing resources for non-convex function optimization.

Example 200A includes a server 210, which comprises a optimization engine 212, which generally performs operations related to automatic function optimization, such as to determine optimal prices for generation of targeted offers (e.g., offer 218) of goods or services to customers (e.g., via a client application 222 on a client 222, such as a user device).

Optimization engine 212 includes an MIP model 214 and a solver 216. MIP model 214 is a model where one or more of the decision variables are constrained to being integer values at the optimal solution. An MIP solver (e.g., solver 216) generally relies on an array of heuristics to solve MIP problems represented in models, such as using branch-and-cut techniques. MIP solvers generally solve a relaxed version of the problem, with some constraints being ignored or replaced with less stringent constraints and with an upper bound being placed on the true optimal value (e.g., to allow an MIP problem to be solved in a reasonable amount of time and without excessive utilization of physical computing resources). If a relaxed solution is determined to be feasible it may be considered optimal, or otherwise the feasible region (branch) may be divided and the process repeated. Such an MIP model may be used in embodiments of the present disclosure.

According to certain embodiments, MIP model 214 is generated based on a plurality of constraints, and is formed in such a manner as to be solved by solver 216 in a resource-efficient manner (e.g., without requiring direct evaluation of non-convex functions). In some embodiments, MIP model 214 involves approximating a non-convex function as the difference between piecewise linear functions and utilizing a Taylor polynomial expansion (e.g., first degree Taylor polynomial expansion) to simplify exponential constraints for resource-efficient evaluation.

For instance, MIP model 214 may be generated for automatically determining optimal pricing for consumer lending products. One example of generating MIP model 214 begins by specifying the term of loans that are to be offered, denoted as T months. Usually T is between 12 and 72. In some embodiments, historical funded T-month loans from third-party data are segmented into n risk segments. For example, base APR per segment may be the average APR for customers in this segment. In some cases, volume stands for the funded dollar amount for loans. For each historical loan, the cumulative principle balance B until the last payment can be determined. The interest yield per payment period is defined as the cumulative interests collected over B. The loss rate per payment period is defined as remaining unpaid principle balance over B. To make interest yield and loss rate annualized, the rate is multiplied by T.

The following parameters may be extracted from these funded loans for each i∈[1, 2, . . . , n] to serve as the base values, assuming that the customer base to which offers are to be targeted is similar to the third-party data:
BLᵢ:=base annualized loss rate in segment i;
BIᵢ:=base APR in segment i;
BYᵢ:=base annualized interest yield in segment i;
BVᵢ:=base proportion of total funded volume in segment i; and
BTᵢ:=base take rate in segment i, which is the funded volume out of the pre-approved loans volume.

The following parameters are based on expert knowledge of the impact of changing APR on take rate and loss rate:
TRᵢ:=percent reduction of take rate when APR increases by 1 percentage point in segment i; and
ASᵢ:=augment factor on annualized loss rate when take rate is smaller than base take rate in segment i.

The following parameters may be specified by business domain experts:
GM:=minimum NAR (net annual return), with NAR being defined as the difference between volume-weighted average interest yield and volume-weighted average annualized loss rate across all segments, normalized by total volume;
Aₘᵢₙ:=minimum APR that could be offered;
Aₘₐₓ:=maximum APR that could be offered;
STEP:=one unit of APR. An APR offered in each segment must be a multiple of STEP, with STEP usually being set to 0.25%;
DIFF:=minimum difference of APRs offered between two adjacent segments;
Vᵢ^{min}=minimum proportion of total volume in segment i; and
Vᵢ^{max}=maximum proportion of total volume in segment i.

In some embodiments, decision variables are defined to carry interest rate, loss rate, weighted interest yield, weight loss and indicator of take rate changes, for each i∈[1, 2, . . . , n].
vᵢ=APR offered for segment i, Aₘᵢₙ≤vᵢ≤Aₘₐₓ;
xᵢ=annualized interest yield for segment i, because customers in the same segment share the same APR, Xᵢ could be interpreted as APY (Annual Percentage Yield) in segment i;
tᵢ=take rate in segment i, 0≤tᵢ≤1;
yᵢ=annualized loss rate in segment i, 0≤yᵢ≤1;
wᵢ=volume-weighted APY in segment i, 0≤wᵢ≤1;
lᵢ=volume-weighted annualized loss rate in segment i, 0≤lᵢ≤1;
zᵢ=0 if take rate decreases from the base take rate, 1 otherwise. zᵢ∈{0,1}; and
mᵢ=multiple of STEP to construct vᵢ, mᵢ∈ [symbol] ⁺.

An objective of MIP model 214 is to determine competitive APRs compared to other alternative lenders so as to attract more customers to a lending product and rapidly gather more data on customer behavior in order to continually improve function optimization and better serve a customer base. Therefore, an objective function is defined as maximizing the reduction of APRs across segments, as follows:

max Σᵢ₌₁ⁿ(BIᵢ−vᵢ) (1).

If the lending product is successful at a testing stage, future pricing strategy may have a different objective. For example, another objective may be to maximize total profit (i.e., collected interests minus loss), which may be represented as follows:

max Σᵢ₌₁ⁿ(wᵢ−lᵢ) (2).

Function (2) expresses the total profit as the multiple on the base funded volume. For market expansion, an objective may be to maximize total funded volume TV as defined in function (3) below. Here, BVᵢ/BTᵢ is the approved volume in segment i. Given the new take rate tᵢ, BVᵢ/BTᵢ*tᵢ is the total funded volume in the new strategy in segment i:

$$TV = {\sum }_{i = 1}^{n} \frac{{BV}_{i}}{{BT}_{i}} {t}_{i} . \qquad ( 3 )$$

Constraints are generally expressed as inequalities and equalities in terms of decision variables and parameters so as to ensure that the solution from MIP model 214 accommodates all applicable business requirements. Example constraints (4)-(19) are set forth below:

$${t}_{i} = {BT}_{i} - {BT}_{i} \cdot {TR}_{i} ( {v}_{i} - {BT}_{i} ) \cdot 100 , \qquad ( 4 )$$

$$i = 1 , … , n ;$$

$${x}_{i} = {( 1 + {v}_{i} / T )}^{T} - 1 \qquad ( 5 )$$

$$i = 1 , … , n ;$$

$${w}_{i} = \frac{{BV}_{i}}{{BT}_{i}} {t}_{i} {x}_{i} \qquad ( 6 )$$

$$i = 1 , … , n ;$$

$${v}_{i} = STEP \cdot {m}_{i} \qquad ( 7 )$$

$$i = 1 , … , n ;$$

$${v}_{i} \geq {V}_{i + 1} + DIFF \qquad ( 8 )$$

$$i = 1 , … , n ;$$

$${A}_{min} \leq {v}_{i} \leq {A}_{max} \qquad ( 9 )$$

$$i = 1 , … , n ;$$

$${z}_{i} \leq \frac{{t}_{i}}{{BT}_{i}} , \qquad ( 10 )$$

$$i = 1 , … , n ;$$

$${t}_{i} - {BT}_{i} \leq ( 1 - {BT}_{i} ) {z}_{i} , \qquad ( 11 )$$

$$i = 1 , … , n ;$$

$${y}_{i} = ( 1 - {z}_{i} ) \cdot {BL}_{i} \cdot {AS}_{i} + {z}_{i} \cdot {BL}_{i} , \qquad ( 12 )$$

$${z}_{i} \leq \frac{{t}_{i}}{{BT}_{i}} ,$$

$${l}_{i} = \frac{{BV}_{i}}{{BT}_{i}} {t}_{i} {y}_{i} \qquad ( 13 )$$

$$i = 1 , … , n ;$$

$${x}_{i} \geq {y}_{i} , \qquad ( 14 )$$

$$i = 1 , … , n ;$$

$${\sum }_{i = 1}^{n} ( {w}_{i} - {l}_{i} ) \geq GM {\sum }_{k = 1}^{n} ( \frac{{BV}_{i}}{{BT}_{i}} {t}_{i} ) ; \qquad ( 15 )$$

$${V}_{i}^{min} {\sum }_{k = 1}^{n} \frac{{BV}_{k}}{{BT}_{k}} {t}_{k} \leq \frac{{BV}_{i}}{{BT}_{i}} {t}_{i} \leq {V}_{i}^{max} \frac{{BV}_{k}}{{BT}_{k}} {t}_{k} \qquad ( 16 )$$

$$i = 1 , … , n ;$$

$$0 \leq {x}_{i} , {y}_{i} , {w}_{i} , {l}_{i} \leq 1 , \qquad ( 17 )$$

$$i = 1 , … , n ;$$

$${z}_{i} ∈ \{ 0 , 1 \} \qquad ( 18 )$$

$$i = 1 , … , n ;$$

$$and$$

$${m}_{i} ∈ {ℤ}^{+} \qquad ( 19 )$$

$$i = 1 , … , n .$$

Constraints (4)-(9) impose requirements on APR and annualized interest yield. Constraint (4) relates to take rate with respect to interest rate. The term (vᵢ−BTᵢ)·100 represents the percentage point changes from the base APR to the assigned APR in a candidate strategy. Take rate tᵢ will decrease from the base take rate BTᵢ if vᵢ is higher than the base APR (BIₜ) and will increase from the base take rate BTᵢ if vᵢ is lower than the base APR (BIᵢ). Customers in a lower-risk bucket are usually more sensitive to APR changes, while customers in higher-risk bucket generally accept a broader range of APRs due to the urgency to obtain borrowed funds to help with financial liquidity and solvency. Constraint (5) relates APY (xᵢ) with APR (vᵢ). Constraint (6) computes the weighted interest yield, which is the proportion of volume in the new strategy times the APY. Constraint (7) ensures that each APR offered to customers is a multiple of STEP, avoiding a fractional value with many decimal points like 11.5438%. Constraint (8) enforces the monotonicity trend and enough distinctions among APRs across segments. Constraint (9) limits the APR values to the range specified by business requirements.

Constraints (10)-(13) impose constraints on annualized loss rate. If an offered APR is (vᵢ) is higher than the base APR (BIᵢ), then, as a result, take rate tᵢ will be below base take rate BTᵢ. As such, constraint (10) forces zᵢ to be 0 in this circumstance. On the other hand, if tᵢ is above BTᵢ, constraint (11) forces zᵢ to be 1 so that the right-hand-side is an upper bound on tᵢ−BTᵢ. Constraint (12) relates annualized loss rate to take rate in order to depict the adverse selection effect. Similar to the formulation in (6), constraint (13) computes the weighted annualized loss rate.

Constraint (14) ensures that, in each segment, the interest yield is no less than the loss rate on annualized basis. Constraint (15) sets the lower bound of NAR that the new product should achieve. The NAR of a segment i is defined as (20) below, and NAR=Σᵢ₌₁ⁿ NARᵢ:

NARᵢ=(wᵢ−lᵢ)/TV (20).

Constraint (16) limits each segment's volume % (21) between a lower bound and upper bound specified by business requirements. If there is no limit on loan concentration, the lower bounds could be set to 0 for all segments and the upper bounds could be set to 1 for all segments. Constraints (17) to (19) set each decision variable's range and data type (continuous or discrete):

$${vol}_{i} \% = \frac{{BV}_{i} / {BT}_{i} \cdot {t}_{i}}{TV} . \qquad ( 21 )$$

The model formulation set forth above contains both continuous and integer decision variables. Also, constraints (6) and (13) are not convex because they include the product of two variables. Let ƒ(α, β)=αβ. The Hessian matrix of ƒ has a negative determinant, indicating the existence of a saddle point. Therefore, gradient descent methodologies are ineffective for solving this problem. As such, embodiments of the present disclosure involve an innovative technique for turning ƒ into a difference between two piecewise linear functions. This methodology is especially effective in a loan pricing model, given that the APRs are not usually offered in a wide range of values. Furthermore the exponential expression in constraint (5) will be transformed into a linear approximation by using the first degree Taylor polynomial (22), set forth below:

$${x}_{i} = {( 1 + \frac{{BI}_{i}}{T} )}^{T - 1} ( 1 - \frac{T - 1}{T} {BI}_{i} + {v}_{i} ) - 1 , \qquad ( 22 )$$

$$i ∈ 1 , … , n .$$

This approximation works particularly well when the decision variable bounds are not particularly far away from the base value, such as in the case of consumer lending pricing. Finally, the model will be turned into an MIP model (e.g., MIP model 214), and thus may be solved by any open-source or commercial MIP solver (e.g., solver 216).

A non-convex function ƒ can be re-written as follows:

$$f ( α , β ) = g ( \frac{α + β}{2} ) - g ( \frac{α - β}{2} ) ,$$

where g(u)=u². Now the non-convex function ƒ is expressed as the difference between two convex and separable functions. Subsequently, piecewise linear approximations of each convex function are determined. Constraint (15) sets a lower bound on NAR, so the approximation on the interest yield involving terms tᵢxᵢ should be an under-estimate, and the approximation on the loss rate involving terms tᵢyᵢ should be an over-estimate. This ensures that the solution does not violate the NAR boundary. Therefore, two piecewise linear approximations are proposed on function g(u) for an over-estimate (denoted as g^{o}(u)) and an under-estimate (denoted as gₒ(u)), respectively. In model implementation,

$$f ( {t}_{i} , {x}_{i} ) := {g}_{0} ( \frac{{x}_{i} + {t}_{i}}{2} ) - {g}^{o} ( \frac{{x}_{i} - {t}_{i}}{2} ) , and f ( {t}_{i} , {y}_{i} ) := {g}^{o} ( \frac{{y}_{i} + {t}_{i}}{2} ) - {g}_{0} ( \frac{{y}_{i} - {t}_{i}}{2} ) .$$

To construct g^{o}(u), an ordered list of M break points between the lower bound and upper bound of u is found, denoted as PT=[PT₁, PT2, . . . , PT_{M}], and set g^{o}(PTⱼ)=PTⱼ². By dotting linear lines between adjacent break points and their function values, a piecewise linear function above the curve of g(u) is obtained. Certain techniques involve setting PT₁=LB(u), PT_{M}=UB(u), and selecting several break points around the base values u₀ in between, such as u₀−0.5|u₀|, u₀−0.25|u₀|, u₀, u₀+0.25|u₀| and u₀+0.5|u₀|, etc. The granularity on approximation points can be determined based on each specific use case. If the break points go from negative values to positive values, it is a good practice to add 0 as one of the break points as well. Now, given any u, it can be expressed as an affine combination of points in PT, so g(u) could be approximated by using the same affine combination of weights on [g^{o}(PT₁), . . . , g^{o}(PT_{M})].

To construct gₒ(u), the tangent line at each point in list PT may be found, and this may be denoted as h(u|PTⱼ)=PTⱼ²+2PTⱼ(u−PTⱼ). By connecting the tangent lines, a piecewise linear function below the curve of g(u) is obtained. The intersection point between two adjacent tangent lines, h(u|PTⱼ) and h(u|PTⱼ₊₁), is (PTⱼ+PTⱼ₊₁)/2, corresponding to an under-estimate function value at PTⱼPTⱼ₊₁. Accordingly, embodiments involve setting gₒ((PTⱼ+PTⱼ₊₁)/2)=PTⱼPTⱼ₊₁. The break points in the under-estimate function are

$$[ P {T}_{1} , \frac{P {T}_{1} + P {T}_{2}}{2} , \frac{P {T}_{2} + P {T}_{3}}{2} , … , \frac{P {T}_{M - 1} + P {T}_{M}}{2} , {PT}_{M} ] .$$

In an example, tᵢxᵢ in constraint (6) may be used to demonstrate how to model the piecewise linear approximation.

$$Let {p}_{i} = \frac{{x}_{i} + {t}_{i}}{2} and {q}_{i} = \frac{{x}_{i} - {t}_{i}}{2} , so {t}_{i} {x}_{i} = {p}_{i}^{2} - {q}_{i}^{2} .$$

First, the lower and upper bounds on pᵢ and qᵢ should be found. Because business requirements specify bounds on APR, constraint (5) can be used to find bounds on xᵢ: LB(xᵢ)=(1+Aₘᵢₙ/T)^{T}−1 and UB(xᵢ)=(1+Aₘₐₓ/T)^{T}−1. Similarly, constraint (4) can be used to find bounds on tᵢ: LB(tᵢ)=BTᵢ−BTᵢ·TRᵢ(Aₘₐₓ−BTᵢ)·100 and UB(tᵢ)=BTᵢ−BTᵢ·TRᵢ(Aₘᵢₙ−BTᵢ)·100. Next, an under-estimate approximation can be determined for pᵢ² as a piecewise linear function gₒ(pᵢ), and an over-estimate approximation can be determined for qᵢ² as a piecewise linear function g^{o}(qᵢ). The following parameters may be derived from the approximation functions:

$$P {T}_{i}^{+} = list of {K}_{i}^{+} break points in {g}_{o} ( {p}_{i} ) , with {PT}_{i 1}^{+} = \frac{L B ( {x}_{i} ) + L B ( {t}_{i} )}{2} and {PT}_{i {K}_{i}^{+}}^{+} = \frac{UB ( {x}_{i} ) + UB ( {t}_{i} )}{2} ;$$

$$P {T}_{i}^{-} = list of {K}_{i}^{-} break points in {g}^{o} ( {q}_{i} ) , with {PT}_{i 1}^{-} = \frac{LB ( {x}_{i} ) - UB ( {t}_{i} )}{2} and {PT}_{i {K}_{i}^{-}}^{-} = \frac{UB ( {x}_{i} ) - LB ( {t}_{i} )}{2} ;$$

$${PF}_{i}^{+} = list of {g}_{0} ( P {T}_{ij}^{+} ) values , j ∈ 1 , … , {K}_{i}^{+} ; and$$

$${PF}_{i}^{-} = list of {g}^{o} ( {PT}_{ij}^{-} ) values , j ∈ 1 , … , {K}_{i}^{-} .$$

Furthermore, additional decision variables may be introduced to carry the affine combinations on break points and approximation function values:
wᵢ⁺=approximation of pᵢ² for i∈1, . . . , n;
wᵢ⁻=approximation of qᵢ² for i∈1, . . . , n;
λᵢⱼ⁺=weight of point PTᵢⱼ⁺ in an affine combination that represents pᵢ, for i∈1, . . . , n, j∈1, . . . , Kᵢ⁺;
λᵢⱼ⁻=weight of point PTᵢⱼ⁻ in an affine combination that represents qᵢ, for i∈1, . . . , n, j∈1, . . . , Kᵢ⁻;
sᵢⱼ⁺=1 if λᵢⱼ⁺>0, 0 otherwise, for i∈1, . . . , n, j∈1, . . . , Kᵢ⁺; and
sᵢⱼ⁻=1 if λᵢⱼ⁻>0, 0 otherwise, for i∈1, . . . , n, j∈1, . . . , Kᵢ⁻.

To approximate pᵢ², i.e.

$${( \frac{{x}_{i} + {t}_{i}}{2} )}^{2} ,$$

the following additional constraints are introduced:

$$\frac{{x}_{i} + {t}_{i}}{2} = {\sum }_{j = 1}^{{K}_{i}^{+}} {λ}_{ij}^{+} P {T}_{ij}^{+} ; \qquad ( 23 )$$

$${w}_{i}^{+} = {\sum }_{j = 1}^{{K}_{i}^{+}} {λ}_{ij}^{+} P {F}_{ij}^{+} ; \qquad ( 24 )$$

$${\sum }_{j = 1}^{{K}_{i}^{+}} {λ}_{ij}^{+} = 1 ; \qquad ( 25 )$$

$${s}_{ij}^{+} \geq {λ}_{ij}^{+} ; \qquad ( 26 )$$

$${\sum }_{j = 1}^{{K}_{i}^{+}} {s}_{ij}^{+} \leq 2 ; and \qquad ( 27 )$$

$${s}_{ij}^{+} + {s}_{{ij}^{′}}^{+} \leq 1 , j = 1 , … , {K}_{i}^{+} , {j}^{′} = j + 2 , … , {K}_{i}^{+} . \qquad ( 28 )$$

Constraint (23) represents pᵢ as a linear combination of points in PTᵢ⁺. Constraint (24) approximates pᵢ² as a linear combination of points in PFᵢ⁺. Constraint (25) ensures that the linear combination must be affine. Constraint (26) relates the binary indicator sᵢⱼ⁺ to the affine combination weight λᵢⱼ⁺. Constraints (27) and (28) together ensure that at most two adjacent affine combination weights could be positive. In other words, if

$$P {T}_{ij} \leq \frac{{x}_{i} + {t}_{i}}{2} \leq P {T}_{i , j + 1} ,$$

then only λᵢⱼ⁺ and λᵢⱼ₊₁⁺ could be positive and λᵢⱼ⁺+λ_{i,j+1}⁺=1, while all other affine combination weights stay 0.

Approximating qᵢ² may involve representing

$$\frac{{x}_{i} - {t}_{i}}{2}$$

as a linear combination of points in PTᵢ⁻ as described in constraint (29), and introducing an additional set of constraints by switching all superscript from + to − in (24) to (28):

$$\frac{{x}_{i} - {t}_{i}}{2} = {\sum }_{j = 1}^{{K}_{i}^{-}} {λ}_{ij}^{-} P {T}_{ij}^{-} . \qquad ( 29 )$$

Constraint (6) may be then be represented as the difference between two piecewise linear functions:

$${w}_{i} = \frac{B {V}_{i}}{B {T}_{i}} ( {w}_{i}^{+} - {w}_{i}^{-} ) . \qquad ( 30 )$$

Similarly, to process the non-convex constraint (13), the entire procedure is described above with respect to constraint (6) may be repeated with customized break points for tᵢyᵢ, i∈1, . . . , n. Thus, to produce MIP model 214, one or more non-convex functions may be approximated, as depicted in FIG. 2B.

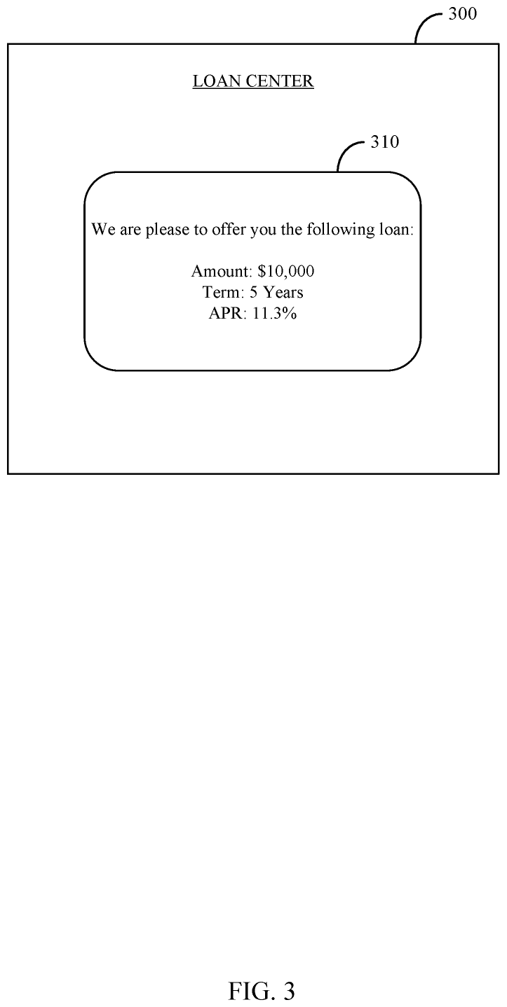

In order to determine offer 218, optimization engine 212 may solve MIP model 214 using solver 216 for a variety of risk segments corresponding to users associated with user data 230. For example, user data 230 may include information associated users that is used to assign users to risk segments. Examples of user data 230 include credit scores, credit history, information about users' assets and/or liabilities, financial transaction histories of users, income data, employment data, and/or the like. Thus, an offer 218 may be directed to a particular user of client 220 based on a solution to MIP model 214 for a risk segment to which the particular user corresponds (e.g., determined based on user data 230). Providing an offer such as offer 218 to a user via a client application such as client application 222 is described in more detail below with respect to FIG. 3.

Experimental results indicate that the linear approximation of xᵢ computing using techniques described herein closely follows the actual APYᵢ, with at most 0.3 percentage points difference. Furthermore, in experiments, APR decreased from the base in each segment and the loss rate yⱼ stayed the same as BLᵢ, so the approximation of lᵢ was accurate at each prescribed tᵢyᵢ. The experimental results further indicated that TV=144%, indicating that a lender utilizing techniques described herein could acquire 44% more customers than could be achieved using conventional automated pricing techniques. Furthermore, results indicated that the wall time for solving the MIP model was significantly less than the time typically required by conventional techniques and fast enough to provide real-time results (e.g., for providing offers to customers in real-time during use of a software application).

### Expert of Non-Convex Function Approximation

FIG. 2B is an illustration 200B of an example related to non-convex function approximation for efficient utilization of physical computing resources.

Non-convex function 240 may represent, for example, a relationship between price and propensity to accept an offer (e.g., which may represent demand). In certain embodiments, non-convex function 240 relates to the product of two decision variables (e.g., xy). The format of xy may resemble many use cases where y changes with x and the target to optimize involves the product of these two variables. In one example, x is price and y is demand, so y decreases as x increases, and the goal is to maximize revenue as xy. In a particular example, non-convex function 240 represents constraint (6) described above with respect to FIG. 2B.

Non-convex function 240 may be approximated based on the difference between two convex functions 250 and 252. For example, if non-convex function 240 is ƒ(tᵢ, xᵢ), it may be approximated as

$${g}_{o} ( \frac{{x}_{i} + {t}_{i}}{2} ) - {g}^{o} ( \frac{{x}_{i} - {t}_{i}}{2} ) ,$$

with convex function 250 being

$${g}_{o} ( \frac{{x}_{i} + {t}_{i}}{2} )$$

and convex function 252 being

$${g}^{o} ( \frac{{x}_{i} - {t}_{i}}{2} ) .$$

Evaluating xᵢ may involve exponential computations, which would be time consuming and involve the expenditure of significant physical computing resources. For example, as addressed above with respect to constraint (5) during the discussion of FIG. 2B, xᵢ may be defined as xᵢ=(1+vᵢ/T)^{T}−1 i=1, . . . , n. As such, one or more of convex functions 250 and 252 may be simplified through a piecewise linear approximation 260, such as by transforming exponential expressions into linear approximations using a Taylor polynomial expansion and/or connecting lines across several points on the convex function curve. For example, a first degree Taylor polynomial may be expressed as

$${x}_{i} = {( 1 + \frac{{BI}_{i}}{T} )}^{T - 1} ( 1 - \frac{T - 1}{T} {BI}_{i} + {v}_{i} ) - 1 ,$$

i∈1, . . . , n. As set forth above, Taylor polynomial expansion generally provides an under-estimate of a convex function (e.g., gₒ(u) described above).

In one example, one or more of convex function 250 and 252 is approximated by connecting lines across several points on the convex function curve. This provides an over-estimate (e.g., g^{o}(u) described above) of the convex function, as the line segment between any two points on the convex function does not lie below the graph between the two points.

An under-estimate and an over-estimate are both determined in cases where there is a constraint relating to imposing a lower bound on profit (e.g., revenue minus loss). Thus, in these cases, a lower bound function is approximated on the revenue (e.g., a non-convex function involving the product of two decision variables, such as xy) using a first convex function that is an under-estimate and a second convex function that is an over-estimate. In other use cases, if there is no constraint that involves bounding xy, either method of approximation may be used (e.g., Taylor polynomial expansion or connecting lines across several points on the convex function curve). If there is a constraint involving imposing an upper bound of xy, then the first convex function should be an over-estimate, and the second convex function should be an under-estimate.

A difference 270 between convex function 250 and convex function 252 (one or more of which may be simplified based on piecewise linear approximation 260, such as involving Taylor polynomial expansion and/or connecting lines across several points on the convex function curve) produces an approximation 280 of non-convex function 240.

According to embodiments of the present disclosure, convex function 250 may be evaluated on a first set of physical computing resources (e.g., a first processor or processor core) and convex function 252 may be evaluated on a second set of physical computing resources (e.g., a second processor or processor core), such as in parallel. Furthermore, even if convex functions 220 and 252 are evaluated in succession rather than in parallel, the computation will still require less physical computing resources and time than evaluating non-convex function 240 directly due to the significant reduction in complexity achieved by removing non-convexity and simplifying exponential expressions.

### Example User Interface Screen for Optimized Offers

FIG. 3 illustrates an example user interface screen 300 for optimized offers. For example, user interface screen 300 may correspond to client application 222 of FIG. 2A.

User interface screen 300 represents a screen of a graphical user interface associated with a financial services application. For example, a user may interact with user interface screen 300 to request pricing information for consumer lending products.

An offer 310 is displayed within user interface screen 300, indicating that a loan is being offered with an amount of $10,000, a term of 5 years, and an APR of 11.3%. Offer 310 may correspond to offer 218 of FIG. 2A, and may be generated by optimization engine 212 of FIG. 2A, such as using techniques described herein for efficiently utilizing physical computing resources for automated function optimization. In one example, the APR of 11.3% was determined as a price to offer a particular customer segment to which the user corresponds by evaluating MIP model 214 of FIG. 2A based on various constraints, including a total loan volume of $10,000 and a term of 5 years. For instance, the total loan volume and term may have been specified by the user via the user interface or may have been automatically selected for offer 310 (e.g., based on the best combination of total loan volume, term, and APR available for the customer segment to which the user belongs). Alternatively, rather than pricing being determined based on customer segments, pricing may be determined for individual customers, such as based on customer attributes (e.g., credit score, assets, liabilities, income, and/or the like).

It is noted that user interface screen 300 and offer 310 are included as an example, and other methods of providing offers to users may be employed without departing from the scope of the present disclosure. For example, an offer may be provided to a user via email, text message, phone call, advertisement, social media, and/or the like.

Furthermore, while certain embodiments are described with respect to consumer lending products, techniques described herein may also be utilized to determine other optimal target values, such as pricing for other types of goods and/or services, particular when price is a percentage of a volume. For example, embodiments of the present disclosure may be used to determine a processing fee for use of a payment processing application (e.g., which may be expressed as a percentage of a total volume of a transaction, such as with lower percentages corresponding to higher volumes). For instance, processing fees may be personalized for particular customers (e.g., merchants) or segments of customers. In another example, techniques described herein may be used to determine a subscription fee for use of product or service.

### Example Operations for Efficiently Utilizing Physical Computing Resources for Function Optimization

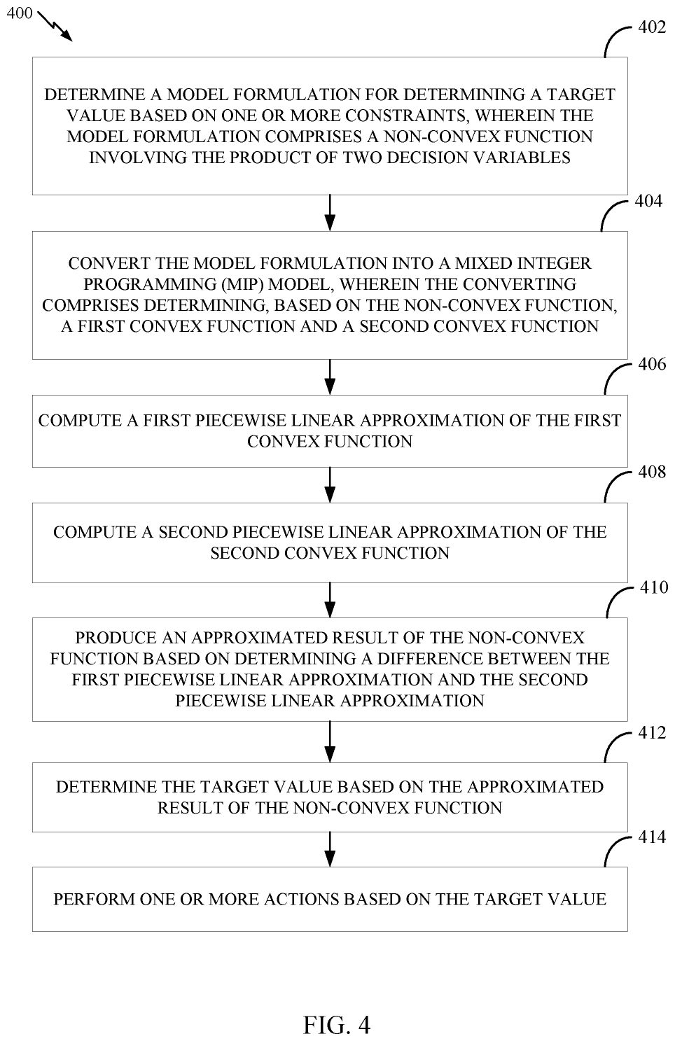

FIG. 4 depicts example operations 400 for efficiently utilizing physical computing resources for function optimization. For example, operations 400 may be performed by optimization engine 212 of FIG. 2A.

Operations 400 begin at step 402, with determining a model formulation for determining a target value based on one or more constraints, wherein the model formulation comprises a non-convex function involving the product of two decision variables. In some embodiments, the one or more constraints relate to offer acceptance likelihood and loss likelihood. In some embodiments, determining the non-convex function represents a relationship between changes in the target value and a likelihood of the target value being successful for its intended purpose (e.g., offer acceptance). The two decision variables may, for example, comprise a price and a demand. In an example, the non-convex function is non-convex function 240 of FIG. 2B.

In certain embodiments, the one or more constraints are based on one or more of: a minimum net annual return; a minimum target value; or time length information (e.g., loan term). For example, these constraints may relate to requirements from an offer provider that are received via input to a user interface. Examples of constraints include constraints (4)-(19) described above with respect to FIG. 2A.

Operations 400 continue at step 404, with converting the model formulation into a mixed integer programming (MIP) model, wherein the converting comprises determining, based on the non-convex function, a first convex function and a second convex function. The MIP model may be solved using an MIP solver (e.g., including steps 406-410). In certain embodiments, the converting (and/or evaluation of the first and/or second convex functions) further comprises simplifying one or more exponential constraints based on a Taylor polynomial expansion for resource-efficient evaluation. Some embodiments further comprise connecting lines across a plurality of points on a curve of one or more of the first and second convex functions. In an example, the first convex function and the second convex function may correspond to convex functions 250 and 252 of FIG. 2B.

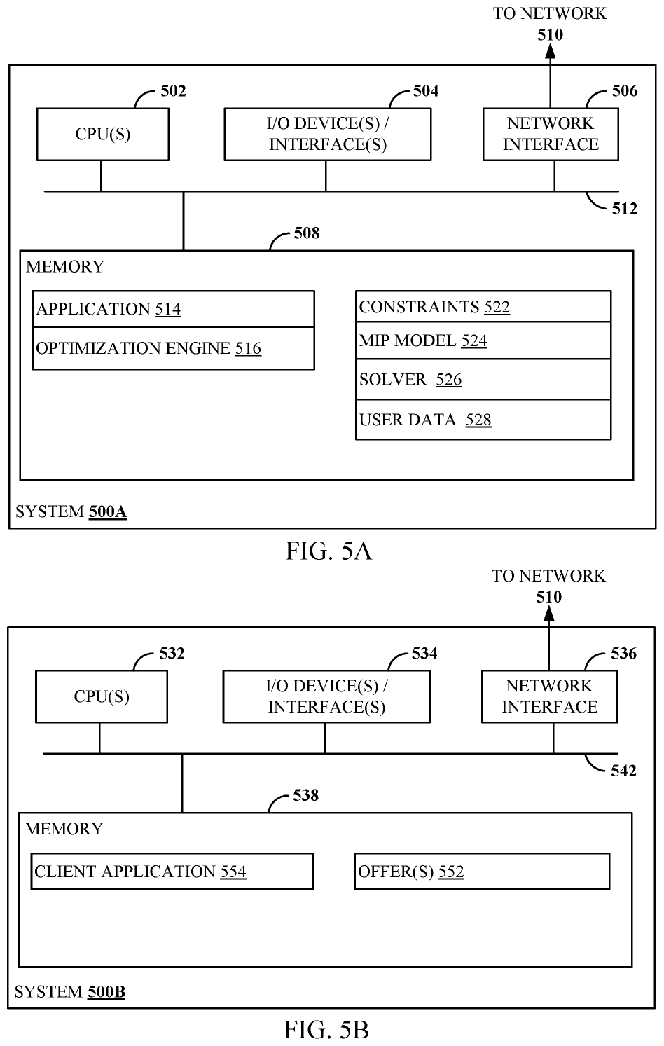

Operations 400 continue at step 406, with computing a first piecewise linear approximation of the first convex function. In some embodiments, the first piecewise linear approximation of the first convex function is computed using a first set of physical computing resources such as corresponding to a first processing device. In such embodiments, the first processing device may correspond to one of CPU(s) 502 of FIG. 5A or one core of a CPU 502 of FIG. 5A.

Operations 400 continue at step 408, with computing a second piecewise linear approximation of the second convex function. In some embodiments, the second piecewise linear approximation of the second convex function is computed using a second set of physical computing resources such as corresponding to a second processing device. In such embodiments, the second processing device may correspond to a different one of CPU(s) 502 of FIG. 5A or a different core of a CPU 502 of FIG. 5A.

Operations 400 continue at step 410, with producing an approximated result of the non-convex function based on determining a difference between the first piecewise linear approximation and the second piecewise linear approximation. For example, the approximated result may correspond to approximation 280 of FIG. 2B based on difference 270 of FIG. 2B.

Operations 400 continue at step 412, with determining the target value based on the approximated result of the non-convex function. The target value may be determined based on a solution to MIP model 214 of FIG. 2A determined using solver 216 of FIG. 2A.

Operations 400 continue at step 414, with performing one or more actions based on the target value. In some embodiments, performing the one or more actions based on the target value comprises providing an offer of a product or service, including the target value (e.g., price), via a user interface. The offer may, for example, correspond to offer 218 of FIG. 2A, and the user interface may correspond to user interface screen 300 of FIG. 3.

In certain embodiments, the one or more constraints further relate to a plurality of user segments, and target value is further determined based on a given user belonging to a given user segment of the plurality of customer segments. For example, determining a user segment to which a customer corresponds may be based on attributes of the user (e.g., credit score, assets, liabilities, income, and/or the like). An offer may be provided based on a target value (e.g., price) determined for the user segment to which the user corresponds.

Notably, method 400 is just one example with a selection of example steps, but additional methods with more, fewer, and/or different steps are possible based on the disclosure herein.

### Example Computing Systems

FIG. 5A illustrates an example system 500 with which embodiments of the present disclosure may be implemented. For example, system 500A may be configured to perform one or more of operations 400 of FIG. 4.

System 500A includes a central processing unit (CPU) 502, one or more I/O device interfaces 504 that may allow for the connection of various I/O devices 514 (e.g., keyboards, displays, mouse devices, pen input, etc.) to the system 500A, network interface 506, a memory 508, and an interconnect 512. It is contemplated that one or more components of system 500A may be located remotely and accessed via a network 510. It is further contemplated that one or more components of system 500A may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes an application 514, which may be a software application through which a business provides offers with pricing determined using techniques described herein, such as by sending offers from a serve-side application 514 to client-side applications on client devices (e.g., client application 554 on system 500B of FIG. 5B). Memory 508 further includes optimization engine 516, which may correspond to optimization engine 212 of FIG. 2A.

Memory 508 further comprises constraints 522, which may include constraints used in generating MIP model 524, such as constraints described above with respect to FIG. 2A (e.g., including non-convex functions). Memory 508 further comprises MIP model 524, solver 526, and user data 528, which may correspond to MIP model 214, solver 216, and user data 230 of FIG. 2A. Generation of MIP model 524 may involve approximating a non-convex function as the difference between piecewise linear functions, and may involve utilizing a Taylor polynomial expansion to simplify exponential constraints, as described above with respect to FIG. 2B.

FIG. 5B illustrates another example system 500B with which embodiments of the present disclosure may be implemented. For example, system 500B may correspond to client 220 of FIG. 2A, and may be configured to display user interface screen 300 of FIG. 3.

System 500B includes a CPU 532, one or more I/O device interfaces 534 that may allow for the connection of various I/O devices 534 (e.g., keyboards, displays, mouse devices, pen input, etc.) to the system 500B, network interface 536, a memory 538, and an interconnect 542. It is contemplated that one or more components of system 500B may be located remotely and accessed via a network 510. It is further contemplated that one or more components of system 500B may comprise physical components or virtualized components.

CPU 532 may retrieve and execute programming instructions stored in the memory 538. Similarly, the CPU 532 may retrieve and store application data residing in the memory 538. The interconnect 542 transmits programming instructions and application data, among the CPU 532, I/O device interface 534, network interface 536, and memory 538. CPU 532 is included to be representative of a single CPU, multiple CPUs, a single CPU having multiple processing cores, and other arrangements.

Additionally, the memory 538 is included to be representative of a random access memory or the like. In some embodiments, memory 538 may comprise a disk drive, solid state drive, or a collection of storage devices distributed across multiple storage systems. Although shown as a single unit, the memory 538 may be a combination of fixed and/or removable storage devices, such as fixed disc drives, removable memory cards or optical storage, network attached storage (NAS), or a storage area-network (SAN).

As shown, memory 538 includes a client application, which may correspond to client application 222 of FIG. 2A, and one or more offers 552, which may include offer 218 of FIG. 2A. For example, an offer 552 may be displayed within a user interface associated with client application 554.

### Example Clauses

Clause 1: A method for efficiently utilizing physical computing resources for non-convex function approximation, comprising: determining a model formulation for determining a target value based on one or more constraints, wherein the model formulation comprises a non-convex function involving a product of two decision variables; converting the model formulation into a mixed integer programming (MIP) model, wherein the converting comprises determining, based on the non-convex function, a first convex function and a second convex function; solving the MIP model, wherein the solving comprises: computing a first piecewise linear approximation of the first convex function; computing a second piecewise linear approximation of the second convex function; and producing an approximated result of the non-convex function based on determining a difference between the first piecewise linear approximation and the second piecewise linear approximation; determining the target value based on the approximated result of the non-convex function; and performing one or more actions based on the target value.

Clause 2: The method of Clause 1, wherein the non-convex function represents a relationship between changes in the target value and a likelihood of the target value being successful for its intended purpose.

Clause 3: The method of any one of Clause 1-2, wherein the two decision variables comprise a price and a demand.

Clause 4: The method of any one of Clause 1-3, wherein the one or more constraints are based on one or more of: a minimum return; a minimum target value; or time length information.

Clause 5: The method of Clause 4, wherein the one or more constraints relate to offer acceptance likelihood and loss likelihood.

Clause 6: The method of any one of Clause 1-5, wherein performing the one or more actions based on the target value comprises providing an offer of a product or service via a user interface, wherein the offer comprises the target value.

Clause 7: The method of any one of Clause 1-6, wherein computing the first piecewise linear approximation of the first convex function is performed on a first processing device, and wherein computing the second piecewise linear approximation of the second convex function is performed on a second processing device.

Clause 8: The method of any one of Clause 1-7, wherein the one or more constraints further relate to a plurality of user segments, and wherein the target value is further determined based on a given user belonging to a given user segment of the plurality of user segments.

Clause 9: The method of any one of Clause 1-8, wherein the converting further comprises simplifying one or more exponential constraints based on a Taylor polynomial expansion for resource-efficient evaluation.

Clause 10: A method for efficiently utilizing physical computing resources for non-convex function approximation, comprising: determining a model formulation for determining target value information based on one or more constraints, wherein the model formulation comprises a non-convex function involving a product of two decision variables; converting the model formulation into a mixed integer programming (MIP) model, wherein the converting comprises determining, based on the non-convex function, a first convex function and a second convex function; solving the MIP model, using an MIP solver, wherein the solving comprises: computing a first piecewise linear approximation of the first convex function based on a Taylor polynomial expansion; computing a second piecewise linear approximation of the second convex function based on connecting lines across a plurality of points on a curve of the second convex function; and producing an approximated result of the non-convex function based on determining a difference between the first piecewise linear approximation and the second piecewise linear approximation; determining the target value information based on the approximated result of the non-convex function; determining a user segment to which a user corresponds based on attributes of the user; and providing a message to the user based on the target value information and the user segment to which the user corresponds.

Clause 11: The method of Clause 10, wherein the non-convex function represents a relationship between changes in the target value and a likelihood of the target value being successful for its intended purpose.

Clause 12: The method of any one of Clause 10-11, wherein the two decision variables comprise a price and a demand.

Clause 13: The method of any one of Clause 10-12, wherein the one or more constraints are based on one or more of: a minimum return; a minimum target value; or time length information.

Clause 14: The method of Clause 13, wherein the one or more constraints relate to offer acceptance likelihood and loss likelihood.

Clause 15: The method of any one of Clause 10-14, wherein performing the one or more actions based on the target value comprises providing an offer of a product or service via a user interface, wherein the offer comprises the target value.

Clause 16: The method of any one of Clause 10-15, wherein computing the first piecewise linear approximation of the first convex function is performed on a first processing device, and wherein computing the second piecewise linear approximation of the second convex function is performed on a second processing device.

Clause 17: A system for efficiently utilizing physical computing resources for non-convex function approximation, the system comprising: one or more processors; and a memory comprising instructions that, when executed by the one or more processors, cause the system to: determine a model formulation for determining a target value based on one or more constraints, wherein the model formulation comprises a non-convex function involving a product of two decision variables; convert the model formulation into a mixed integer programming (MIP) model, wherein the converting comprises determining, based on the non-convex function, a first convex function and a second convex function; solve the MIP model, wherein the solving comprises: computing a first piecewise linear approximation of the first convex function; computing a second piecewise linear approximation of the second convex function; and producing an approximated result of the non-convex function based on determining a difference between the first piecewise linear approximation and the second piecewise linear approximation; determine the target value based on the approximated result of the non-convex function; and perform one or more actions based on the target value.

Clause 18: The system of Clause 17, wherein the non-convex function represents a relationship between changes in the target value and a likelihood of the target value being successful for its intended purpose.

Clause 19: The system of any one of Clause 17-18, wherein the two decision variables comprise a price and a demand.

Clause 20: The system of any one of Clause 17-19, wherein the one or more constraints are based on one or more of: a minimum return; a minimum target value; or time length information.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for efficiently utilizing physical computing resources for non-convex function approximation, comprising:
determining a model formulation for determining a target value based on one or more constraints, wherein the model formulation comprises a non-convex function involving a product of two decision variables;
converting the model formulation into a mixed integer programming (MIP) model, wherein the converting comprises determining, based on the non-convex function, a first convex function and a second convex function;
solving the MIP model, wherein the solving comprises:
computing a first piecewise linear approximation of the first convex function;
computing a second piecewise linear approximation of the second convex function; and
producing an approximated result of the non-convex function based on determining a difference between the first piecewise linear approximation and the second piecewise linear approximation;
determining the target value based on the approximated result of the non-convex function; and
performing one or more actions based on the target value.

2. The method of claim 1, wherein the non-convex function represents a relationship between changes in the target value and a likelihood of the target value being successful for its intended purpose.

3. The method of claim 1, wherein the two decision variables comprise a price and a demand.

4. The method of claim 1, wherein the one or more constraints are based on one or more of:
a minimum return;
a minimum target value; or
time length information.

5. The method of claim 4, wherein the one or more constraints relate to offer acceptance likelihood and loss likelihood.

6. The method of claim 1, wherein performing the one or more actions based on the target value comprises providing an offer of a product or service via a user interface, wherein the offer comprises the target value.

7. The method of claim 1, wherein computing the first piecewise linear approximation of the first convex function is performed on a first processing device, and wherein computing the second piecewise linear approximation of the second convex function is performed on a second processing device.

8. The method of claim 1, wherein the one or more constraints further relate to a plurality of user segments, and wherein the target value is further determined based on a given user belonging to a given user segment of the plurality of user segments.

9. The method of claim 1, wherein the converting further comprises simplifying one or more exponential constraints based on a Taylor polynomial expansion for resource-efficient evaluation.

10. A method for efficiently utilizing physical computing resources for non-convex function approximation, comprising:
determining a model formulation for determining target value information based on one or more constraints, wherein the model formulation comprises a non-convex function involving a product of two decision variables;
converting the model formulation into a mixed integer programming (MIP) model, wherein the converting comprises determining, based on the non-convex function, a first convex function and a second convex function;
solving the MIP model, using an MIP solver, wherein the solving comprises:
computing a first piecewise linear approximation of the first convex function based on a Taylor polynomial expansion;
computing a second piecewise linear approximation of the second convex function based on connecting lines across a plurality of points on a curve of the second convex function; and
producing an approximated result of the non-convex function based on determining a difference between the first piecewise linear approximation and the second piecewise linear approximation;
determining the target value information based on the approximated result of the non-convex function;
determining a user segment to which a user corresponds based on attributes of the user; and
providing a message to the user based on the target value information and the user segment to which the user corresponds.

11. The method of claim 10, wherein the non-convex function represents a relationship between changes in the target value and a likelihood of the target value being successful for its intended purpose.

12. The method of claim 10, wherein the two decision variables comprise a price and a demand.

13. The method of claim 10, wherein the one or more constraints are based on one or more of:
a minimum return;
a minimum target value; or
time length information.

14. The method of claim 13, wherein the one or more constraints relate to offer acceptance likelihood and loss likelihood.

15. The method of claim 10, wherein performing the one or more actions based on the target value comprises providing an offer of a product or service via a user interface, wherein the offer comprises the target value.

16. The method of claim 10, wherein computing the first piecewise linear approximation of the first convex function is performed on a first processing device, and wherein computing the second piecewise linear approximation of the second convex function is performed on a second processing device.

17. A system for efficiently utilizing physical computing resources for non-convex function approximation, the system comprising:
one or more processors; and
a memory comprising instructions that, when executed by the one or more processors, cause the system to:
determine a model formulation for determining a target value based on one or more constraints, wherein the model formulation comprises a non-convex function involving a product of two decision variables;
convert the model formulation into a mixed integer programming (MIP) model, wherein the converting comprises determining, based on the non-convex function, a first convex function and a second convex function;
solve the MIP model, wherein the solving comprises:
computing a first piecewise linear approximation of the first convex function;
computing a second piecewise linear approximation of the second convex function; and
producing an approximated result of the non-convex function based on determining a difference between the first piecewise linear approximation and the second piecewise linear approximation;
determine the target value based on the approximated result of the non-convex function; and
perform one or more actions based on the target value.

18. The system of claim 17, wherein the non-convex function represents a relationship between changes in the target value and a likelihood of the target value being successful for its intended purpose.

19. The system of claim 17, wherein the two decision variables comprise a price and a demand.

20. The system of claim 17, wherein the one or more constraints are based on one or more of:
a minimum return;
a minimum target value; or
time length information.
